(19) United States
(12) Patent Application Publication
(10) Pub. No.: US 2004/0037423 A1
(43) Pub. Date: Feb. 26, 2004

(54) Mobile programs

(76) Inventor: Robert Ghanea-Hercock, Suffolk (GB)

Correspondence Address: NIXON & VANDERHYE, PC, 1100 N GLEBE ROAD, 8TH FLOOR, ARLINGTON, VA, 22201-4714, US

(21) Appl. No.: 10/398,903

(22) PCT Filed: Oct. 15, 2001
(86) PCT No.: PCT/GB01/04600

(30) Foreign Application Priority Data
Oct. 17, 2000 (EP) 00309131.1

(51) Int. Cl. H04K 1/00

(52) U.S. Cl. 380/270

(57) ABSTRACT

A mobile agent computing system comprising at least one computer (10) having a communications port (12) running a host program (70) for facilitating execution of a mobile program (50) received via the port (12), the mobile program (50) including identification data indicative of its type, identity or origin, in which the host program (70) is arranged to test the mobile program for the possible presence of code which is inconsistent with the agent identification data, and to prevent execution of said inconsistent code.

This invention relates to mobile computer programs. Particularly, but not exclusively, this invention relates to mobile agent computing.

A mobile agent as referred to herein is a computer program capable of operating on a computer, and of transferring to another computer and resuming execution thereon.

Mobile agents have been proposed as a means for reducing network load and providing a dynamic and flexible platform for a wide range of applications e.g.

Network Management

Distributed processing

Mobile E-commerce

There are several arguments in favour of mobile agent technology, such as:

They reduce the network load

They overcome network latency

They encapsulate protocols

They adapt dynamically

Advantages often ascribed to mobile agents are:

Persistence—mobile agents allow a fire and forget operation, i.e. a user can launch the agents into a network and the agents will persistently pursue the task until all of the required information is gathered. This is one of the primary advantages autonomous agents can offer. In particular this feature allows the agents to cope with very asynchronous data flows.

Robustness—since the agents can relocate to remote servers they only require temporary network connections.

Efficiency—in supporting large distributed database services mobile agents can perform local search operations, which can out-perform standard remote access methods, i.e. in a client-server model.

Parallelism—a user can divide a search task and assign each component to an agent, which searches a separate server to access the required information. Hence a fan-out mechanism exists.

However, in many applications, there is resistance to the use of mobile agent programs, because of the possibilities they offer for security breaches. In particular, the potential insecurity of mobile agent programs has been the subject of concern in military applications.

For example, it would be desirable to be able to use mobile agent programs in military battlefield situations, since such programs are able to operate autonomously, and asynchronously, without requiring human intervention. However, the danger of allowing programs to arrive and begin execution on a battlefield is self-evident.

There are other applications where it would be desirable to use mobile age in computing, but security considerations make this difficult at present—for example, online commerce, or applications involving database operations on confidential data.

Several different types of security breach may occur. For example, a program may cause malicious damage on the host computer (in the manner of a virus). Alternatively, a program may interrogate a database, and transmit data from the database to a remote location. It may also leave with the data.

Previous attempts to improve the security of mobile agent systems have typically provided authentication processes, such as certification. Such techniques are already widely used in other types of downloaded program, such as applets, or Microsoft Active X controls. Essentially, they provide an indication of the origin of the program.

In the field of applets, rather than mobile agents, the Java language (available from Sun Microsystems) its provides a feature known as the “sandbox”, which provides applets with limited memory resources in which to operate but denies them access to the disk drives of the target computer.

In “Mobile Agents on the Digital Battlefield”, Hofman et al, Autonomous Agents Conference pp219-225, Minneapolis, 1998 the authors describe a mobile agent system in which, to improve communication efficiency, agents discard inessential code before transferring to another computer, and reacquire code on arrival. A “dock” or “port” is provided at each host computer which processes agent arrival and departure, and provides agents with code on request.

In one aspect, the invention provides a computing system in which, on each host, a mobile agent program can be received and allowed to execute, in which the mobile agent program is checked on arrival for the possible presence of unauthorised code, and prevented from executing such code.

Prevention may simply be by refusing to allow the agent to operate. Conveniently, all code for accessing resources on the host (such as files, drives or ports) is kept on the server, and in one embodiment the agent program causes such code to execute by passing a high level message in, for example, an agent communications language (ACL) encoded using, for example, extendible mark-up language (XML). This gives a high degree of transparency; in other words, it is easier to see what the agent program is doing, and hence an enhanced level of security. In another embodiment, after the agent has been security checked, it is supplied with the necessary code for accessing system resources, which is removed from the agent before it moves to another host computer.

In another aspect, the present invention provides a computing system in which hosts are arranged to receive and execute mobile agent programs, in which each agent program contains data indicating actions it will perform, and the data is read by the host computer and used as a security check.

Preferably, the data indicates a list of tasks to be performed at the host by the agent program. In this case, preferably, the host computer is arranged to check the list of tasks before allowing the agent program to carry out any of the tasks. Additionally or alternatively, the host computer is arranged to check whether each task attempted by the agent program conforms to the task data.

The data may also comprise behaviour data indicating responses which the agent program will make under predetermined conditions. In this case, the host programs arranged to monitor the behaviour of the agent program under those conditions, to ensure that it performs as the behaviour data declares that it will.

In another aspect, the invention provides a computer system in which mobile programs arrive at, and are executed on, one or more host computers, in which the mobile programs comprise at least first data encrypted using a key which can be decoded by the host, and second data encrypted using a key which cannot be decrypted by the host by can be decrypted by an authorised host.

In this embodiment, preferably each mobile program also comprises code. Preferably the second data is data generated by the mobile program and the first data is data installed in the mobile program at its creation. The first data may comprise data identifying the identity and/or characteristics of the mobile program and the second data may be the results of calculations or searches performed by the mobile program.

Other aspects, features and preferred embodiments will be apparent from the following description and claims.

Embodiments of the invention will now be illustrated, by way of example only, with reference to the accompanying drawings, in which:

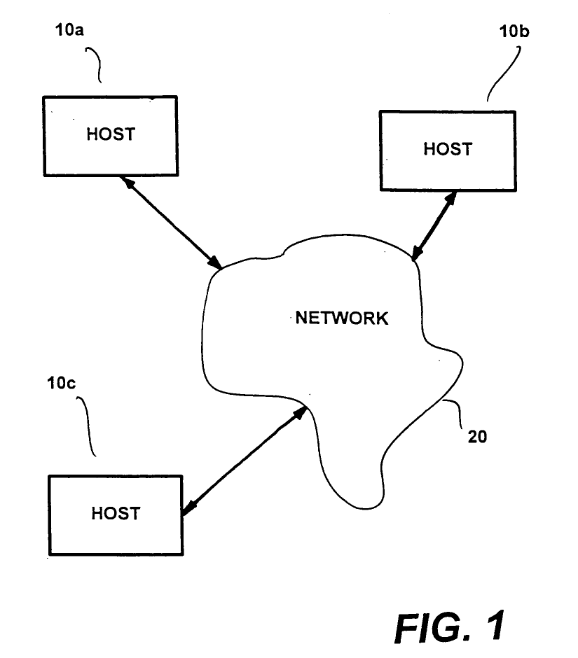

FIG. 1 is a block diagram showing the structure of a system of a first embodiment;

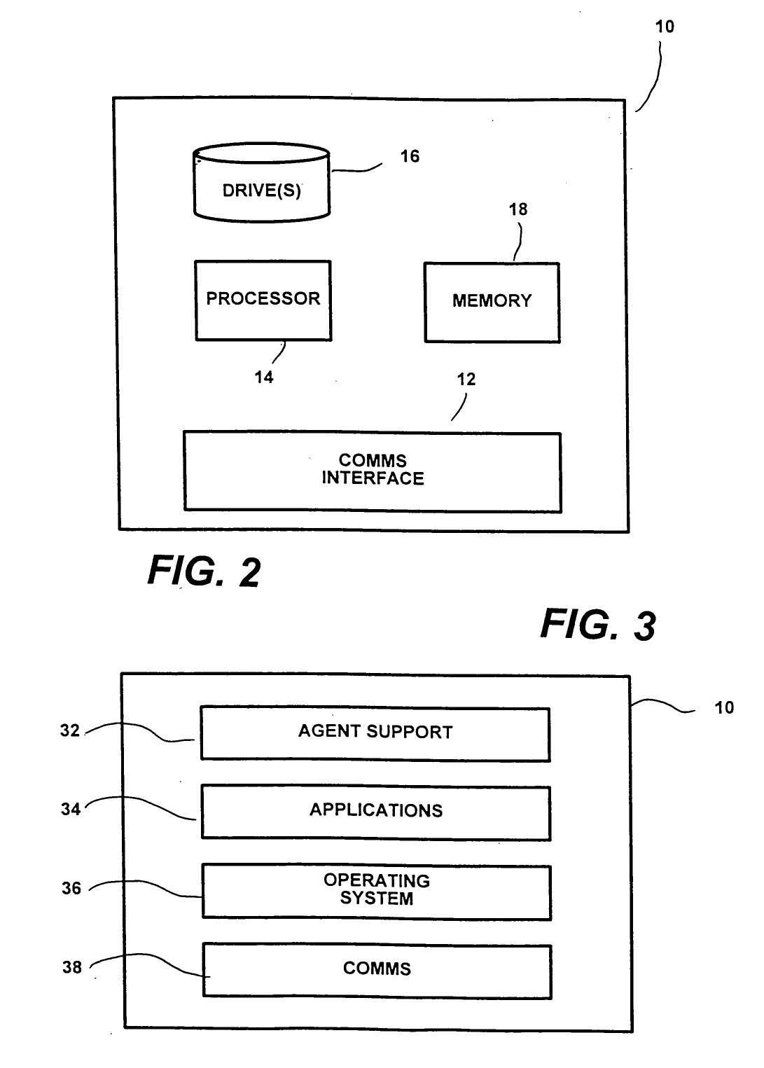

FIG. 2 is a block diagram showing the elements of a host computer according to the first embodiment;

FIG. 3 is a diagram showing the software present on the host computer;

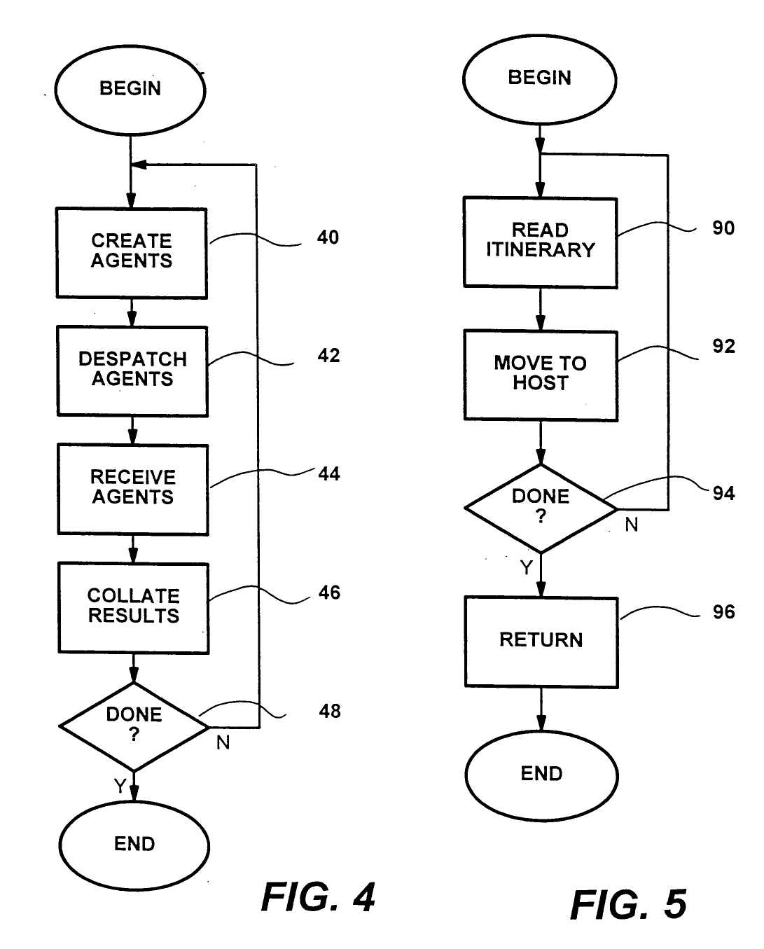

FIG. 4 is a flow diagram showing the overall process of performing a task using mobile agents; and

FIG. 5 is a flow diagram showing the general operation of a mobile agent program;

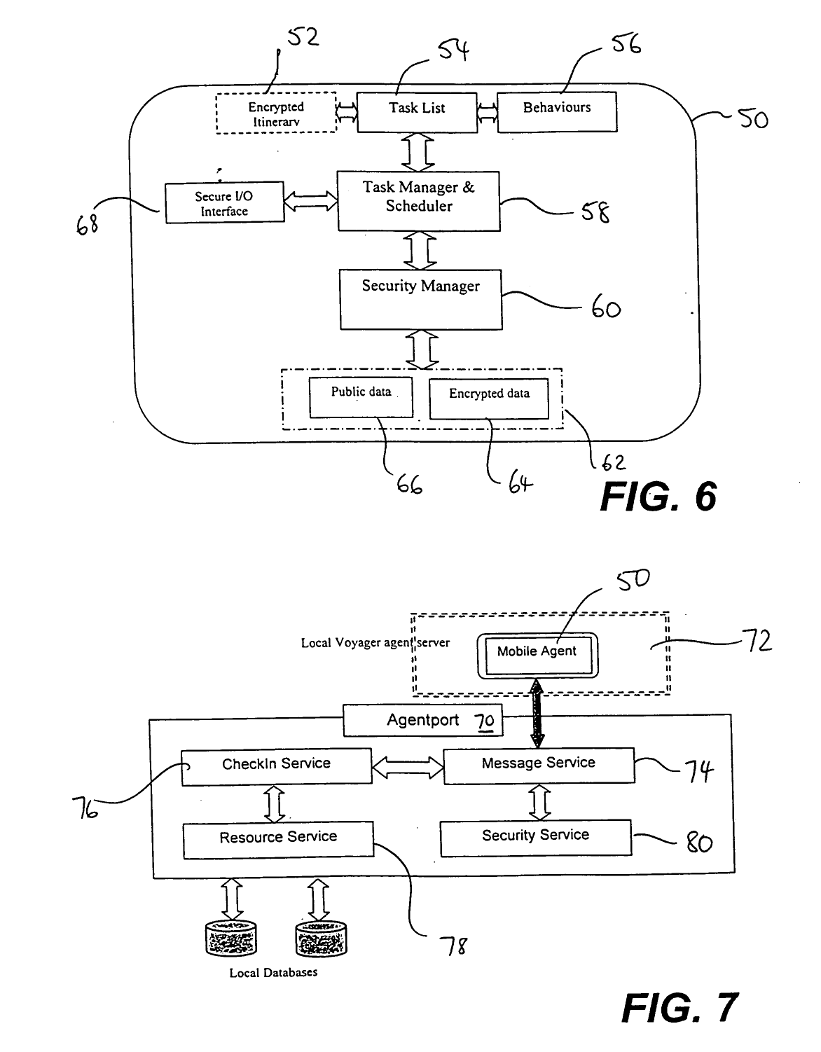

FIG. 6 is a diagram showing the data and programs present in a mobile agent program according to the first embodiment; and

FIG. 7 is a diagram showing in greater detail part of the software present in FIG. 3;

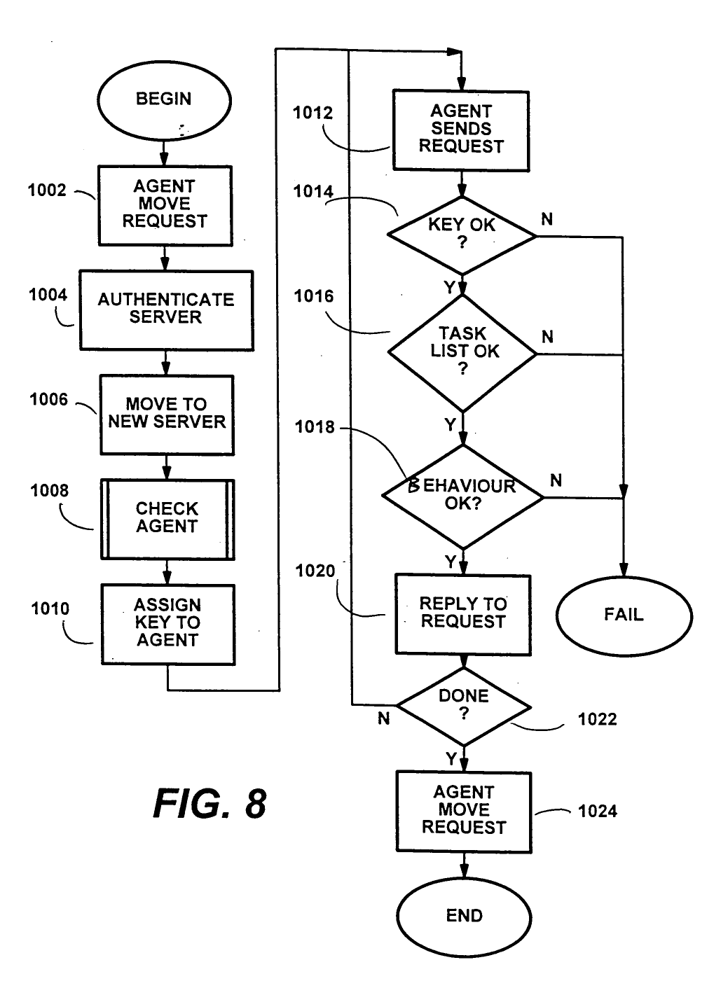

FIG. 8 is a flow diagram showing the process of operation of the embodiment; and

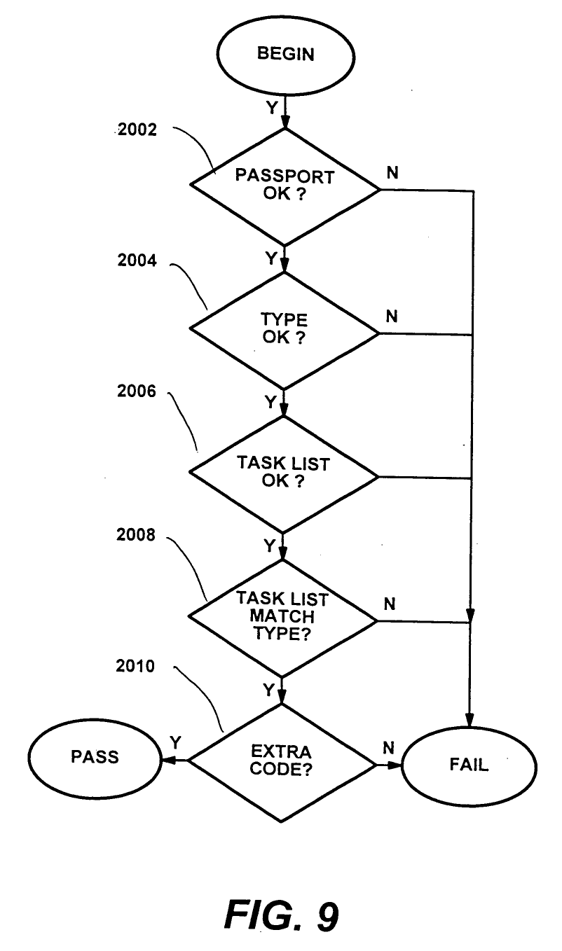

FIG. 9 is a flow diagram showing in greater detail an initial validation stage of the process of FIG. 8;

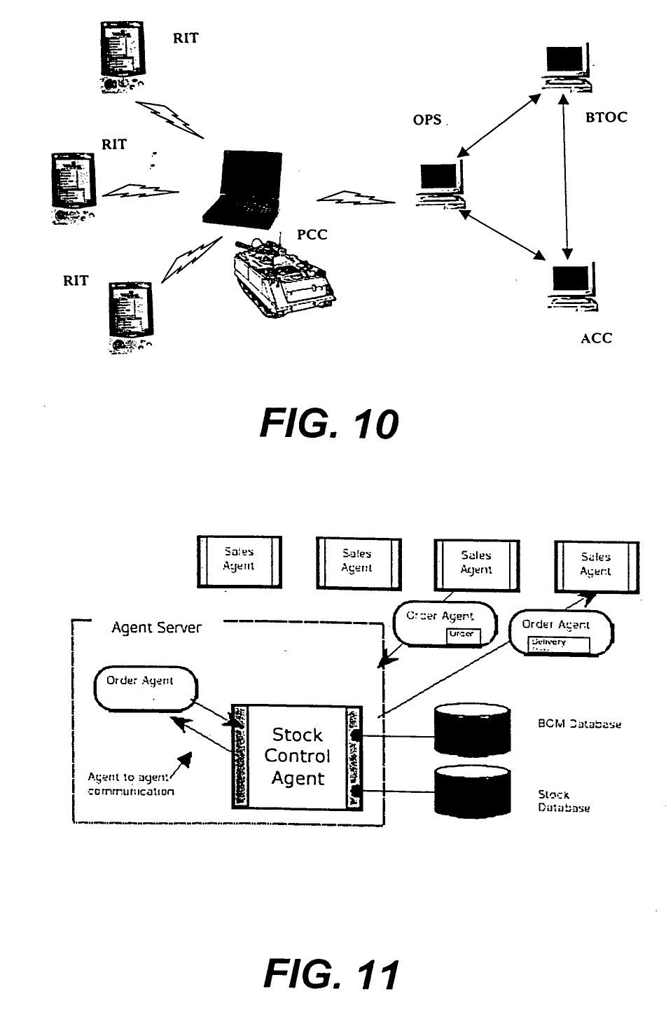

FIG. 10 is a block diagram illustrating schematically the application of the embodiment to a battlefield computing scenario; and

FIG. 11 is a diagram illustrating schematically the application of the first embodiment to a stock control scenario.

Referring to FIG. 1, a plurality of host computers 10a, 10b, 10c, are interconnected via a communications network 20.

For example, in a military battlefield application, the computer 10a may be a portable computer carried by a soldier; the computer 10b may be a local unit control computer carried in an armoured vehicle; and the computer 10c may be provided at a regional headquarters. The communications network 20 may be a wireless data communications network, employing TCP/IP protocol.

Referring to FIG. 2, each host computer comprises a communications interface 12 connected to the network 20, a processor 14, one or more disk drives 16, and memory 18. Referring to FIG. 3, each host computer runs under the control of programs (stored on the drives 16 and uploaded into memory 18 for execution) comprising a communications package 38, an operating system 36 such as Windows NT, Unix or Linux, and one or more applications 34. The communications package 38 is arranged to accept Java objects such as messages and agent programs, and comprises a TCP/IP stack.

Also provided is an agent support program 32. The agent support program 32 comprises support for Java, together with an agent support platform such as Voyager (TM), arranged to provide a communications and message passing for mobile agent programs. All of the above programs are commercially available, and will not be described further. Finally, the agent support program 32 comprises an agent port program, which will be described in greater detail below. The agent port program provides security against attack by unauthorised agents.

Referring to FIG. 4, the general (and known) process of performing a task using agents will be described. The task may, for example, be to collect information on enemy movements from servers in the battlefield. The control computer (not shown, but typically one of the hosts 10) defines the task and controls the agents performing it.

In a step 40, a suitable number of agents 50 are created, and given an identity and an indication of type (e.g. “data collection agent”). The servers 10 are categorised into itineraries, one for each agent 50, and each itinerary is stored in an agent. Tasks are assigned to each agent; for example, to interrogate local databases for records of enemy positions and store the results. In a step 42, the agents are dispatched, each to the first host 10 on its itinerary. In a step 44, the agents are received back, and in a step 46, the data carried (in encrypted form) by each agent is read, and the results are collated. When all agent results are received and collated, in step 48, the process ends.

Referring to FIG. 5, in operation, in a step 90 the agent program 50 reads the itinerary stored within it, and determines the next host computer 10 to visit. In a step 92, the agent program moves to the host thus identified until the entire itinerary has been traversed (step 94). It then returns to its originating computer (step 96).

Referring to FIG. 6, the structure of each agent program will now be described in greater detail. Each agent program 50 comprises data defining an itinerary 52; data defining a task list 54; data defining agent behaviour 56; a task manager and scheduler program 58; a security manager program 60; an input/output secure communications interface 68; and a payload data portion 62 comprising an encrypted data region 64 and a public data region 66.

The itinerary 52, held in a secure store, specifies the servers 10 to be visited by the agent 50, and the task list 54 specifies the tasks to be performed at the servers.

This is an example of task list data of the embodiment;

Typical Task list

Task type: Search and retrieve

Task definition: Reference to a set of SQL commands passed to agent's data store

Priority: High

Security Clearance: xxxxxxxx

Security keys: Reference to keys held in agent's data store

Life span: Duration of job

Itinerary: server A, server B, server C, server D

Task Plan: Move to itinerary servers in sequence

If data delayed at a server, request persist to dB.

On waking resume task plan.

If data unavailable move to next server in itinerary.

At end of itinerary move home, deliver data.

The behaviour data 56 describes how the agent 50 should behave in response to predetermined events on a server when performing tasks there.

The following are examples of possible responses of the agent to specific events:

Example Behaviour Data

Behaviour 1: If next host is unavailable use a threshold or probability function to select when to try next server on itinerary.

Behaviour 2: Monitor sensor data. If local CPU load too high reduce agents thread activity, depending on personal priority level.

Behaviour 3: If Security Manager detects hostile attack, delete data store and try to move to parent server.

Behaviour 4: Detect personal data store is full, transfer data by SSL to home server.

The task manager and scheduler 58 program component controls the operation of the agent to perform the tasks. This is the core reasoning process in the agent, and handles task selection based on current inputs and the task list.

The task manager reads incoming messages from a queue and each message triggers a sequence of actions.

The task manager parses the provided task plan and schedules the necessary services and actions. The relevant manager component is then invoked to provide the specified services. For example, the first process is for the data manager to store any received itinerary data, task lists, and encryption keys. Similarly the task manager may request security services from the Security manager, such as encryption of new data or management of a secure transfer request.

The task list is converted into a set of goals, which are used by a goal-solving reasoning process. The task manager observes the current status of the agent and its current plan. It may operate by checking pre and post condition events when goals have been achieved. It may also monitor input from the current host environment (for example, CPU load, memory levels, other agent activity, or network state e.g. ping times to remote servers).

The security manager 60 is responsible for authentication of the agent, and for storage and retrieval of data in the encrypted data region 64. It also determines which program modules (classes) can be loaded from a host.

The interface 68 provides communication with external programs via secure socket layer (SSL) communications and message calls. Incoming messages are queued for retrieval by the task manager.

The functions of each of these will be apparent from the following description.

Data is stored within the agent 50 in three levels of security access. The first level of data is public access data, which may include the agent's identity and point of origin. The second level of security is encrypted data, which authorised hosts 10 can decrypt using a suitable key held by them. This is to prevent access by unauthorised servers, and interception of the data in transit. The task list and behaviour data is stored at this level. The third level is a write only store in which the agent can store information, but from which it cannot be read without a private key. When the agent has returned to a safe server (i.e. the server on which it was created), an authorised user can extract the secured data. A malicious server can cause data to be stored in that area, but cannot read data out. This level is used to store the results produced by the agent program itself.

Referring to FIG. 7, the structure of the agent port program 70 will now be described in greater detail. The agent port 70 comprises a message server program 74, arranged to communicate via the Voyager platform 72 with agents 50. It also comprises a Check-in service 76, a Resource service 78, and a Security service 80.

The check-in service 76 receives new agents at the server 10 and allocates system resources to them.

The security service 80 maintains local public and private encryption keys and authentication processes. As described below, it is arranged to check an agents authority to move onto the server, and to grant permission to contact other agents and to use local resources.

The Resource Service 78 provides a generic interface to all local databases and applications on the server 10. It is arranged to accept requests for data in a high-level language; In this embodiment, XML.

This embodiment was implemented using Java 1.2, with Objectspace Voyager 1.3 providing support for agent mobility, directory services and SSL communication. A commercial encryption package for Java (Entrust Toolkit version 4.51) was used to provide additional encryption services although an alternative package could be plugged into the system, with minimal modification. Each individual mobile agent was about 76 Kbytes in size.

Referring to FIG. 8, the operation of this embodiment will now be described in greater detail.

In a step 1002, an agent program 50 resident on a host 10a determines that the next host on its itinerary is host 10b. It sends a message to host 10b requesting to move to it. The initial connection from the remote mobile agent may be via a Java socket or a Voyager remote call. The host 10b receives the message, which is processed by the message service 74 of the port 70 and passed to the check-in service 76.

In step 1004, the security service 80 validates the host 10a by a call/response signalling sequence using digital signatures, to determine that it is not an intruder. If the host 10a is authentic 109, then in step 1006, the agent 50 moves to the new server 10b and its identifier (unique ID) is registered with that host, to enable other programs to locate the object for communications with it. (Although not relevant to the present invention, it is mentioned in passing that the registration system used is that provided by the ObjectSpace Voyager agent development kit).

To enable the move, as in a agent systems generally, the agent program 50 causes the host 10a to send the agent (comprising code for performing the task manager and scheduler 58, security manager 60, and secure I/O interface 68, together with the data 52-56, 62-66), as a serial message through the network 20.

In step 1008, the validity of the agent is checked in a process described further in FIG. 9.

If the agent is found to be valid, then in step 1010, the agent is made able to operate. The check in service 76 creates a local agent manager (LAM) program thread of execution to operate on the host 10b, which co-operates with the agent program 50 in its future operations. The local agent manager supplies the agent with a unique temporary access key for communications with the resource service 78. This key is used to encrypt all requests to access local services, so that even if an agent program evades the checks on its validity, it cannot access local resources.

In step 1012, the agent program 50 passes the local agent manager program a request for data (discussed in greater detail below) which is forwarded to the resource service program 78. The resource service program checks the key embedded in the request (step 1014). If the-key is correct, then in step 1016, the resource service checks whether the request matches the task list of the agent 50 (i.e. the agent is only performing tasks which it declared it would perform).

If the request matches the task list then in step 1018, the security service 80 compares the actions performed by the agent 50 with those specified in the behaviour list to determined any mismatch (for example, the agent program may have indicated that it may suspend operation if CPU usage on the host 10b exceeds a certain level; if it does not behave as indicated then it may be an unauthorised agent).

If there is no misbehaviour by the agent, then in step 1020, the resource service performs the request (for example, performs a database search for a given term) and passes the results back to the agent. When all tasks performed by the agent are done (step 1020) the agent's task manager and scheduler program 58 will signal via its secure I/O interface 68 to the next host 10c on its itinerary that it wishes to move, and operation will resume at step 1002.

Referring now to FIG. 9, the initial security checks performed on an agent in step 1008 of FIG. 8 will be discussed further.

In step 2002, the security manager determines whether the passport data carried within the agent is valid. To do so, it analyses the passport and checks the identity, origin, and classes that the agent contains. (The classes of the agent are part of the passport object as a digitally signed object). If so, then in step 2004, the security service compares the agent type data with a list of agent types which are permitted on the host computer 10b. For example, the agent type may be “information retrieval”, “stock control” and so on. Some host computers may permit only agents which retrieve data, and not those which are also capable of writing data on the host.

In step 2006, the security manager 80 reviews the task list of the agent 50. The operations listed on the task list are compared with a predetermined list maintained by the security manager for that host 10b. If there are any tasks on the task list which are not listed by the security manager 80, the agent 50 will not be permitted to execute.

In step 2008, the task list is compared against the agent type reviewed in step 2004. The security manager 80 maintains, for each agent type, a list of tasks permitted to that type on the host. If tasks which are not listed are found to be present in the task list, so that the agent is probably a valid but disfunctional agent, the agent will not be permitted to execute on the host.

Finally, in step 2010, the security manager searches the agent for the presence of extra code. It does so by checking the size of the agent against the appropriate size for an agent of that type, and by string-searching the received code for patterns which correspond to code commands or statements. Whilst it may not be possible to detect any and all unauthorised code which might be present, it will be possible to detect either large amounts of code or code of a predetermined type (e.g. code to execute directory or disc access). As, according to the present embodiments, all such access should be via the agent port program, no agent should be allowed onto the host 10 which carries its own code for accessing resources such as directories, files or input/output devices; in this embodiment, each agent program 50 carries only code for task management and scheduling; security; and communications.

According to the present embodiment, agents request the use of resources on the host by sending high level request messages, rather than by executing code to access resources directly themselves, or executing a procedure call to code on the host. This has several advantages. Firstly, for security purposes there is greater transparency; it is more easy to tell what an agent is doing because the request is more easily interpreted. It is thus possible to eliminate the requirement for agents to contain any code for influencing resources on the host, or even for calling programs on the host.

Secondly, it is easy to provide a consistent interface, and hence to link to existing “legacy” programs; the agent needs no code specific to the particular programs or hosts it is visiting.

According to this embodiment, the resource service program 78 comprises an XML parser for receiving a message in XML (extendible markup language) format and interpreting it as a request to read data from, write data to, or cause the execution of, a resource such as a file, port or program. Coupled to the parser is, for each such resource, a program arranged to call a corresponding read, write or execute function on the resource and return the results (if any). An XML generator program is arranged to generate a corresponding XML format Java object for return to the agent 50, encoded using the temporary key. The parser is also conveniently used to read the task list when received from the agent 50 in XML message format.

XML has previously been suggested as a language enabling communications between agents using so called “knowledge-based” languages; see the FIPA standard for mobile agents ACL at http://www.fipa.org/spec/fipa8a27.doc, and Grosof and Labrouy “An approach to using XML and a rule-based content language with an agent communication language”, Proc. of the IJCAI-99 workshop on agent communication languages (ACL-99) and IBM research report RC21491 (May 28, 1999). It is convenient for embodiments of the invention to utilise these agent-agent communication language standards in agent-port communications.

One XML parser which may be suitable is the Voyager DXML product available from ObjectSpace Inc.

Below is the listing of a task list request message according to this embodiment:

Example Tasklist Request Message.

<?xml version=“1.0”?>

<!DOCTYPE tasklist (View Source for full doctype . . . )>

<tasklist>

<task type=“insert”>

<insert>

<table>requisitions</table>

<column>demander</column>

<column>location</column>

<column>nsn</column>

<column>quantity</column>

<value>‘btagent’</value>

<value>‘btlabs’</value>

<value>4441</value>

<value>20</value>

</insert>

</task>

</tasklist>

Example of an ACL Formatted Message

An example message from a mobile agent to the agent port could be:

(Request

| :agent-name GUID | |
|---|---|
| :receiver | “local host” |
| :content | (SQL query) |
| :ontology | data access |
| :language | client defined |
| :signature | key |

)

Example of XML Formatted ACL Message.

Below is the above message in an XML format.

<?xml version=″1.0″?>
<DOCTYPE fipa_acl SYSTEM ″fipa_acl.dtd″>
<message>

<messagetype>

request

</messagetype>
<messageparameter>

<agent-name>
GUID
</agent-name>

</messageparameter>
<messageparameter>

<receiver>
local host
</receiver>

</messageparameter>
<messageparameter>

<content>
SQL query
</content>

</messageparameter>
<messageparameter>

<ontology>
data access
</ontology>

</messageparameter>
<messageparameter>

<language>
client defined
</language>

</messageparameter>
<messageparameter>

<signature>
key
</signature>

</messageparameter>

</message>

The above embodiment has several advantages.

The system protects security of individual agents in several ways. Firstly, if an agent is intercepted by a hostile server, the server can not interrogate the agent to discover the class methods it uses to access legitimate servers resources; as that code is resident on the legitimate servers themselves. (This also improves the security of the hosts, as information about accessing their data resources is not visible).

Second, any critical data carried by the agent is held in an encrypted format. Since the keys to access the data are held within secured hosts, the agents data is secure. If an agent requires access to data concerned with its reasoning and task selection processes, it can request the server it is resident on to decrypt that data for the agent.

The mobile agents retain the ability to plan and process their list of tasks. Only the ability to access local resources is removed from their code, i.e. knowledge access operates on a ‘need to know’ basis.

Since the mobile agents have no classes for accessing local resources, their footprint (i.e. size), and therefore the impact they have on the network load, is reduced.

As the host servers maintain all classes needed to access local resources, then the mobile agents can communicate with a common interface at each server. This simplifies the design of the agents and isolates proprietary code at the local hosts. This also aids scalability of the system and makes future development easier.

All local agent to agent interaction passes through the port. This improves isolation of the mobile agents from each other, which is needed to protect them from potentially hostile local agents, which are currently sharing the same host server.

The advantages of local processing performance and data access have been retained, whilst isolating the host servers from potential attack by malicious agents. In particular the ability to isolate knowledge of hosts data access methods should improve the acceptability of mobile agent technology to commercial organisations.

The action taken in the above embodiment on detection of a security breach is typically to disable the agent and prevent it from operating (e.g. by erasing it from local resources). It may also include notifying other host computers by message of the identity of the agent, to prevent further breaches, and/or to notify the original host from which the agent was created.

It will be apparent that many changes to the above embodiment may be made. For example, in one embodiment, rather than controlling local resources by passing messages, once an agent has been authenticated it could be allocated local code (as in the above-referenced paper by Hofman et al). It would in principle be possible for all code portions of the agent to be maintained at the hosts 10, reducing the agent to a “smart message” containing only its operating state data. However, this reduces the flexibility which can be provided within agents. Although it is convenient to use Java as an implementation platform because of the isolation from system resources provided by the Java sandbox, other platforms for creating agents exist, and the invention can be implemented using these.

Where the term “host” and “server” is used above to describe the computers 10, this is not intended to limit their function; it will be clear that they could comprise mainframe computers, desktop computers, laptop computers, or suitably powerful personal digital assistants as necessary.

It may be convenient to provide user interfaces at one or more host computers, to allow visualisation of the operation of the agents as an additional security measure.

A number of example and scenarios showing applications of the invention will now be given.

Information Discovery

A first set of applications of the invention are in the role of information discovery, and these will be illustrated by civil and military scenarios.

Industrial Scenario—Electronic Commerce A user requires information regarding the best supplier of a particular service. The necessary information is distributed throughout the users corporate Intranet and in several online databases. The user loads their agent interface toolkit and creates a single mobile agent with the required search task. The agent queries the users personal profile record and selects a number of possible servers to retrieve the data from. The agent contacts the first server on its itinerary and makes a secure transfer request to the Agent port resident on that server. The remote port validates the request from the agent and allows the agent to move into the port. The agent requests access to the local database and loads the required access classes from the local class store. After acquiring the needed information and storing it within a suitably secure area of its code, the agent attempts to contact and move to the next server on its itinerary. If the next server is not available and no alternative exists then the agent requests its current host port to persist the agent and provide a wake event signal when the required server is available

Military Scenario

Consider the following scenario for a military intelligence battlefield domain, in which a tactical information gathering system is deployed over several units. These are comprised of the following:

Remote Intelligence Team (RIT)

Platoon Control centre (PCC)

Analysis and Control centre (ACC)

Company Operations centre (Ops)

Battalion Tactical Operations centre (BTOC)

These represent typical military intelligence units required in a battlefield domain. Several RIT units are deployed over a battlefield domain with command links between them as shown in FIG. 10.

Intelligence Support

An RIT unit observes enemy movements in their sector and enters the data and co-ordinates into their mobile terminal. The terminal software associates the data with a mobile agent, which then waits for a radio link to the PCC unit. A link becomes available and the agent moves to the PCC unit, and informs the local Agent port that it has a high-priority data message. The Agent port authenticates the agents ID and opens an immediate radio link to the OPS unit. The agent moves to OPS and after validation is allocated a place in the OPS priority queue to await further processing or redirection. At some point the agent is allocated priority and is pushed to the ACC unit where the data is extracted and entered into the operational database.

An analyst in BTOC requests information regarding enemy movements and launches several mobile agents to simultaneously query all available data sources. Mobile agents move to OPS and the ACC servers and initiate requests for new information on enemy movements. The OPS unit agent management system decides that the task has sufficient priority to make a broadcast request for fresh data to all PCC units. It generates several mobile agents, assigns the search task to each and launches them in parallel to all PCC units via the wireless network. On arriving at each PCC the agents query the local Agent port for fresh information and persist themselves to local storage, to await a wake event when the local database has the requested data. Later an RIT unit acquires new enemy movements and uploads these to the PCC via a mobile agent. The PCC Agent port recognises the requested data and sends a wake signal to the relevant mobile agent. The agent stores the data and returns via the OPS unit to BTOC and resolves the original analyst's request.

Supply Chain Sales Order Processing

A second set of applications are in the field of supply chain sales order processing. A strong case can be made for using mobile agents to support order allocation in distributed supply databases. A heterogeneous system of static and mobile agents can improve the efficiency of such commercial databases. Clearly, any military operation also has need for similar supply and order processes.

The key concept is that mobile agents can move from one distributed stock database to another to acquire a completed product specification or order as shown in FIG. 11. The agents can also wait at supply servers until new stock becomes available.

Supply Chain Support

As discussed above, mobile agents can enhance the operation of a distributed supply or stock database system. This is illustrated in the following scenario.

A large military force has been deployed in a regional zone of conflict, with extensive deployment of ground and naval forces. A strategic supply chain system has been implemented reaching from local OPS units in the field, back to civil equipment contractors in the home country.

A flight engineer requires a new engine and radar for an F18 aircraft and enters the request into his local requisition system. The system acts as an interface to a mobile agent based data network. A mobile agent is tasked with transferring the request to the relevant supply database and reporting a response when available. The agent moves via a secured transfer to the regional supply database and registers its request with the local Agent port system.

The Agent port provides access to its local databases and the agent recovers details of available radar stocks held on the system. The agent then requests transfer to a database supporting engine units and gathers data there on engine availability. However, the database reports that no engines are currently available but units are expected in the near future. The agent decides to copy itself and sends the copy back to its home server with the current state of the order and requests a persist state from its current host, with a wake event signal when the engines are available.

The Agent port hosting the engine stocks database makes a request for new stock to the contracted suppliers, using a mobile agent. The request details are held in a strongly encrypted format, which requires private key access at the contractor's server. This is to protect the knowledge that the airforce has no supply of spare engines at present.

Battlefield Data Management

Mobile agents can also be used to support the input and retrieval of information from the distributed databases within a tactical domain. (There is clearly a degree of commonality between the information discovery and database support roles).

Mobile Computing

A third set of applications use the invention in mobile computing. The principal goal of applying mobile agents to mobile platforms is to exploit asynchronous communications, i.e. to overcome the intermittent connection of such platforms. However, the imminent arrival of high capacity, multi-media PDA devices with telecommunication capabilities, (e.g. the Symbian and EPOC alliance) may provide a wider range of potential applications for mobile agent technology, (in both civil and military domains).

There are two main roles in applying mobile agents for mobile devices. Firstly, to support a fire and forget launching of information search requests, and second to support automatic management of network connections and applications.

Industrial Application

A large telecommunications company has several thousand field engineers equipped with laptop class computers. The computers have a cellular low bandwidth link to the engineer's home service centre, which delivers the daily and weekly work schedules. The schedules themselves are generated by a computer based, regional planning and scheduling system. At the start of each working period the engineer logs onto the network and initiates a work request. A mobile agent is generated by the local Agent port and transmitted to the home service centre, via the cellular link. At the service centre the agent makes the necessary requests for work schedules and jobs for its user, and stores these in its own data store. If a link is still available to the engineers machine the agent jumps back and delivers the required job schedules. If the link is down the agent is persisted to disk and waits for a wake event from the host agent port. The agent can also receive wake events when any changes to the engineer's schedule are received and sends a copy of itself to the engineer when a link is open.

Later that day the regional scheduling system modifies the engineers work plan to accommodate an extra job. The new schedule is passed to a mobile agent with the Id of the engineer. The agent moves to the engineers home service centre and informs the agent port that it has a message for the particular engineer. The agent port wakes the engineer's agent and the scheduling agent delivers the new schedule. The scheduling agent sends a message to the regional centre to confirm that the new schedule was delivered and then deletes itself.

Military Application

A battlefield domain contains a large number of mobile units, from individual soldiers to local command centres. Wireless networks are therefore an integral aspect of such systems and require an efficient means of data transfer. The properties of such a network are:

Automatic management to minimise the task load on the users.

Optimised speed/efficiency of data transfer to reduce r.f traffic, i.e. radio silence.

Plug and play capability for new hardware and software applications.

The importance of mobile hardware will also increase as the capabilities of such devices increases. For example they may contain large local databases, which will require frequent automatic updates from command centres.

Military Scenario A group of ten soldiers are gathering intelligence on enemy movements. The officer of the group decides to move to a new position and enters the co-ordinates and command into his mobile computer. The resident agent system encrypts the message and assigns it to a mobile agent. The agent opens a radio link to the local command centre (Ops) and transfers itself over. The agent footprint is less than 15 kB and the transfer completes in <5 seconds on a 64 Kb/sec link. At the Ops unit the agent informs the host agent port of its mission and then clones itself ten times. The Ops centre database is therefore automatically updated with the unit's movements. Each agent clone then requests a radio link to its target soldier, and when available transfers to the soldiers mobile computer. The agent delivers the new commands and coordinate data and terminates.

At the new position the officer realises that a high threat situation exists for his troops and issues a pull back command, via his mobile computer. The onboard agent system processes the high-priority message and tests for direct radio contact with each troop member. A mobile agent is assigned the message and is launched to each member's mobile computer in parallel. Each agent also has a fan out command and on arrival if no copy of itself has already arrived, immediately copies itself and jumps to all units within radio range. Each soldier receives the new command within 10 seconds and the unit falls back.

These civil and military scenarios demonstrate how mobile agents are well suited to supporting data retrieval and integration when the supply of information is intermittent and very asynchronous. In such cases they offer a significant advantage over normal remote procedure call methods.

1. A computing system comprising at least one computer (10) having a communications port (12), arranged to run a host program (70) for facilitating execution of a mobile program (50) received via said port (12), said mobile program (50) including identification data indicative of its type, identity or origin, characterised in that said host program (70) is arranged to test said mobile program for the possible presence of code which is inconsistent with said identification data, and to prevent execution of said inconsistent code.

2. A system according to claim 1, in which said mobile program comprises code arranged to execute at a first said computer (10); to store data and to cause the transmission to said code and said data to a second said computer for execution thereon.

3. A system according to claim 2, in which said data is encrypted by an encryption algorithm which cannot be used to decrypt said data.

4. A system according to claim 3, in which said encryption algorithm is a public key algorithm and said data can be decrypted by a corresponding private key.

5. A system according to claim 3, in which said data comprises result data derived from the execution of said mobile program on said computer (10) and in which said computer (10) cannot decrypt said result data.

6. A system according to claim 3, in which said data comprises description data, descriptive of the mobile program (50), and in which said computer (10) decrypt said description data.

7. A system according to claim 1, in which said mobile program comprises itinerary data indicating a sequence of said computers (10) to be visited by said mobile program.

8. A computing system comprising at least one computer (10) arranged to run mobile agent programs, the computer being arranged to check for the presence of unauthorised code within said agent programs (50) and to deny access to its resources to programs (50) containing such unauthorised code.

9. A computing system comprising at least one computer (10) arranged to receive, and allow execution of, a mobile program (50), the mobile program (50) comprising data on actions which may be performed by said mobile program on said computer (10), in which the computer (10) is arranged to read said data and to allow or deny access to its resources in dependence thereon.

10. A system according to claim 9 in which the data comprises task list data, defining the sequence of tasks to be performed by said mobile program (50).

11. A system according to claim 10 in which said computer (10) is arranged to read said task list data prior to allowing said mobile program (50) to operate, and to allow said program (50) to operate only where said task list data is in accordance with predetermined conditions.

12. A system according to claim 10 or claim 11, in which the computer (10) is arranged to compare actions performed by said mobile program (50) with those of said task list, and to prevent performance of said tasks unless they correspond to said task list.

13. A system according to claim 9, in which said data comprises behaviour data indicating the behaviour of said mobile program (50) in response to predetermined external conditions.

14. A computer system comprising one or more computers (10) arranged to execute mobile programs (50), said mobile programs comprising at least first encrypted data which can be decrypted by said computers (10) and second encrypted data which cannot be decoded by said computers (10).

15. A system according to claim 14, in which the second encrypted data comprises data generated by said mobile program (50) at said computers (10).

16. A computer system comprising at least one computer (10) arranged to run a host program (70) for facilitating execution of a mobile program (50) received at said computer (10), in which said mobile program (50) is arranged to use resources on the computer (10) by passing a message to the host program (70).

17. A system according to claim 16 in which the host program (70) is arranged to supply authentication data to the mobile program (50) and the mobile program (50) is arranged to generate said messages using said authentication data, and the host program (50) is arranged to check said messages for conformity with said authentication data.

18. A computer (10) programmed to operate within a system according to any preceding claim.

19. A host program (70) suitable for execution on a computer according to claim 18 to facilitate operation of a mobile program (50) thereon.

20. A mobile program (50) for use in the system of any of claims 1-17.

21. A computer program product comprising a storage medium carrying code representing a program according to claim 19 or claim 20.
